(19) United States
(12) Patent Application Publication
(10) Pub. No.: US 2025/0210711 A1
(43) Pub. Date: Jun. 26, 2025

(54) ADDITIVE FOR SECONDARY BATTERY AND LITHIUM METAL BATTERY INCLUDING THE SAME

(71) Applicants: LG Energy Solution, Ltd., Seoul (KR); KOREA ADVANCED INSTITUTE OF SCIENCE AND TECHNOLOGY, Daejeon (KR)

(72) Inventors: Jiheong Kang, Daejeon (KR); Jinha Jang, Daejeon (KR); Chan Beum Park, Daejeon (KR)

(21) Appl. No.: 18/851,020

(22) PCT Filed: Jan. 6, 2023
(86) PCT No.: PCT/KR2023/000306

§ 371 Date: Sep. 25, 2024

(30) Foreign Application Priority Data
Apr. 29, 2022 (KR) 10-2022-0053361

(51) Int. Cl. H01M 10/0567; H01M 4/02; H01M 4/134; H01M 4/38; H01M 4/485; H01M 10/0525; H01M 10/0568

(52) U.S. Cl. CPC H01M 10/0567; H01M 4/134; H01M 4/382; H01M 4/485; H01M 10/0525; H01M 10/0568; H01M 2004/027; H01M 2004/028

(57) ABSTRACT

An additive for a secondary battery and a lithium metal battery including the same are provided. The additive comprises an ionic liquid compound that includes a cation and an anion and is in a liquid state at an atmospheric pressure and at a temperature of 100° C. or less. The cation has a standard reduction potential lower than that of lithium cation (Li⁺) based on a standard hydrogen electrode (SHE) and has a structure in which an even number of aliphatic hydrocarbon groups having 3 or more carbon atoms identical to each other are bonded to a central element of the cation such that the cation has a symmetrical structure based on the central element. The additive is capable of suppressing dendritic lithium growth and induce uniform lithium growth on lithium metal thin films, thereby improving performance and life of the lithium metal battery.

### CROSS-REFERENCE TO RELATED APPLICATIONS

This application is a National Phase entry pursuant to 35 U.S.C. § 371 of International Application No. PCT/KR2023/000306 filed on Jan. 6, 2023, and claims the benefit of Korean Patent Application No. 10-2022-0053361 filed on Apr. 29, 2022, the disclosures of which are incorporated herein by reference in their entirety.

### FIELD

The present disclosure relates to an additive for a secondary battery that can suppress dendritic lithium growth and induce uniform lithium growth on lithium metal thin films, thus improving performance and life of the lithium metal battery, and a lithium metal including the same.

### BACKGROUND

A lithium metal battery is a battery that applies a Li-metal thin film as an anode active material, and has the advantage that it has theoretically high energy density and capacity (3860 mAh g⁻¹) as compared to a secondary battery that applies a graphite-based anode or the like that have been used in the past. Thus, research and development about this have been continuously performed in order to apply the lithium metal battery to a secondary battery that requires high energy density.

However, the lithium metal battery has a problem that, due to the characteristics of lithium metal acting as an anode active material, the volume of the anode varies greatly during charging and discharging, and dendritic lithium generated during charging grows to form lithium dendrites. If such lithium dendrites continue to grow, there is a drawback that it may penetrate the separator and cause an internal short circuit in the cell, which results in major problems in the performance of the secondary battery, may cause safety problems such as ignition, and greatly reduces the life characteristics of the secondary battery.

It can be considered that the growth of dendritic lithium and lithium dendrites on the lithium thin film occur because the flow of lithium ions during charging and discharging concentrates on the protuberance of the lithium tip as a strong electric field concentrates on the lithium tip forming portion as compared to a flat portion.

In particular, since lithium metal, which acts as an anode active material in a lithium metal battery, has a high reactivity with the electrolyte, an irreversible reaction may occur steadily during the charge and discharge process. Dendritic lithium and lithium dendrites that grow rapidly due to this irreversible reaction can disrupt the solid electrolyte interphase (SEI) film on the lithium metal thin film, which may further promote the irreversible reaction. As a result, continuous irreversible reaction, dendritic lithium growth and the like occur during the charge and discharge process of the lithium metal battery, capacity characteristics and performance of the cell are rapidly deteriorated, and life characteristics and safety of the lithium metal battery may be greatly deteriorated.

Due to these problems of the existing lithium metal batteries, researches have been progressed in various ways on techniques for solving the problems caused by the dendritic lithium growth or the like by forming a lithium metal thin film, more specifically, a protective film on the lithium tip or protuberance, or strengthening a solid electrolyte interface film.

As one of such techniques, a method has been proposed in which an ionic liquid compound that exists in a liquid state containing cations and anions at the operating temperature of the battery is used as an additive. The cations of the ionic liquid compound can be adsorbed on the surface of the lithium tip to form a protective layer, thereby repulsing lithium ions around the lithium tip. As a result, it is possible to suppress a phenomenon in which the flow of lithium ions concentrates around the lithium chip and protuberance, thus suppressing rapid growth of dendritic lithium or lithium dendrites and inducing uniform lithium growth. Therefore, if the ionic liquid compound is used as an additive, it is known that problems caused by the rapid dendritic lithium growth can be alleviated to some extent.

However, as previously proposed ionic liquid compounds have high amphiphilicity, they show a strong propensity of being self-aggregated around the lithium tip. As a result, it was confirmed that the cations of the ionic liquid compound did not completely cover the lithium chip, thus forming an incomplete protective layer, so that the problem caused by dendritic lithium or lithium dendrite growth still appeared.

Therefore, there is a continuous demand for the development of technologies such as additives that can further reduce problems caused by dendritic lithium or lithium dendrite growth or the like in lithium metal batteries.

### SUMMARY

It is an object of the present disclosure to provide an additive for a secondary battery that can form a uniform protective layer around the lithium tip or the like, thus suppressing dendritic lithium growth, inducing a uniform lithium growth on lithium metal thin films, and improving performance and life of the lithium metal battery.

It is an object of the present disclosure to provide a lithium metal battery which incorporates the additive in the electrolyte, thus exhibiting more improved life characteristics and safety.

According to one aspect of the present disclosure, there is provided an additive for a secondary battery comprising an ionic liquid compound that includes a cation and an anion and is in a liquid state at an atmospheric pressure and at a temperature of 100° C. or less, wherein the cation has a standard reduction potential lower than that of lithium cation (Li⁺) based on a standard hydrogen electrode (SHE), and wherein the cation has a structure in which an even number of aliphatic hydrocarbon groups having 3 or more carbon atoms identical to each other are bonded to a central element of the cation, such that the cation has a symmetrical structure based on the central element.

In the additive for a secondary battery, the cation may have a standard reduction potential of −3.7V to −3.1V, or −3.65V to −3.15V, or −3.6V to −3.3V based on the standard hydrogen electrode. Therefore, even during charge/discharge and operation of secondary batteries such as a lithium metal battery, the cations are not substantially decomposed, and an anti-lithium protective layer can be formed on the lithium metal thin film. In addition, cations having such a low standard reduction potential are preferentially adsorbed over lithium ions on the lithium tip surface of the lithium metal thin film, so that a selective protective layer can be formed on the lithium tip.

Further, in the additive for a secondary battery, the cation can exhibit the features that a self-diffusivity calculated according to the Stejskal-Tanner equation using the analysis results of PFG-NMR (Pulsed Field Gradient-NMR) is 15×10⁻¹¹ m²·s⁻¹ to 30×10⁻¹¹ m²·s⁻¹, or 18×10⁻¹¹ m²·s⁻¹ to 28×10⁻¹¹ m²s⁻¹, or 20×10⁻¹¹ m²·s⁻¹ to 25×10⁻¹¹ m²·s⁻¹, and that a hydrodynamic diameter calculated according to the Stockes-Einstein equation using the PFG-NMR analysis results is 1.5 to 3.0 nm, or 1.8 to 2.8 nm, or 2.0 to 2.5 nm.

The self-diffusivity and the hydrodynamic diameter may reflect lower amphiphilicity compared to additives containing a cation with asymmetrical structure, especially lower interaction with non-aqueous organic solvents included in the electrolyte, as the cations of the additive have a plurality of long-chain aliphatic hydrocarbon groups identical to each other, for example, long-chain straight-chain alkyl groups, into a symmetrical structure. Therefore, the cations of the additive have a low tendency to self-aggregate around the lithium tip or protuberance, and evenly adsorb or bond onto the lithium tip to form a protective layer that selectively and uniformly surrounds the lithium tip. Therefore, the use of such an additive can more effectively suppress the growth of dendritic lithium or lithium dendrites from the lithium tip.

In order for the additive to exhibit these effects, the plurality of long-chain aliphatic hydrocarbon groups are alkyl groups having 3 or more carbon atoms, or 3 to 20 carbon atoms, or 4 to 15 carbon atoms, or 5 to 10 carbon atoms, more preferably a linear alkyl group having such carbon atoms. An even number of such hydrocarbon groups can be bonded to the central element of the cation, so that the cation can have a symmetrical structure.

According to a specific example, the ionic liquid compound of the additive may be represented by the following Chemical Formula 1, and more specifically, it may be represented by the following Chemical Formula 2:

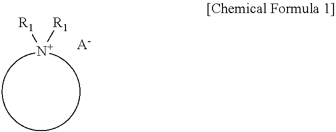

wherein, in Chemical Formula 1,

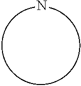

is a nitrogen-containing heterocyclic ring having 3 to 8 carbon atoms, or 4 to 7 carbon atoms, or 5 to 6 carbon atoms, R1s are linear alkyl groups having 3 to 20 carbon atoms, or 4 to 15 carbon atoms, or 5 to 10 carbon atoms, which are identical to each other, and A⁻ represents an anion.

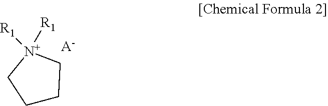

wherein, in Chemical Formula 2, R1s are linear alkyl groups having 3 to 20 carbon atoms, or 4 to 15 carbon atoms, or 5 to 10 carbon atoms, which are identical to each other, and A⁻ is an anion.

Meanwhile, according to another aspect of the present disclosure, there is provided a lithium metal battery including the additive. Such a lithium metal battery includes an anode including a lithium metal thin film formed on the anode current collector; an electrolyte including the above-mentioned additive; and a cathode including a cathode active material layer formed on a cathode current collector.

The lithium metal battery may further comprise a protective layer formed on the lithium metal thin film and containing the cations of the additive, wherein in the protective layer, the cations of the additive can be adsorbed or bonded on the dendritic lithium so as to selectively cover the dendritic lithium protruding from the lithium metal thin film.

Since the additive of the present disclosure is an ionic liquid compound and the cation thereof has a low standard reduction potential, the cation can better adsorb than lithium ions on the surface of the lithium metal anode to form a protective layer. In particular, the additive can form a selective protective layer on the lithium tip forming portion where the flow of lithium ions concentrates during charging and discharging.

In addition, as the cation of the additive has a long-chain aliphatic hydrocarbon group having lithiophobic properties, it is possible to repulse the lithium ion around the lithium tip. As a result, the growth of dendritic lithium or lithium dendrites from the lithium tip is suppressed, and uniform lithium as a whole can be grown on the lithium metal anode.

In addition, as the cationic structure of the additive exhibits moderated amphiphilicity, the phenomenon of self-aggregation of the cations is reduced. As a result, a uniform protective layer can be selectively formed around the lithium tip, and a phenomenon in which the protective layer is not properly formed in some areas around the lithium tip can be minimized.

Therefore, when a secondary battery such as a lithium metal battery is provided using the above additive as an electrolyte additive, the growth of dendritic lithium or lithium dendrites on the lithium metal anode can be greatly reduced, and uniform lithium can grow on the lithium metal anode during charge/discharge process.

Therefore, such a lithium metal battery can minimize safety problems such as cell short circuit or ignition caused by the dendritic lithium growth, maintain high capacity characteristic unique to a lithium metal battery for a long time, and exhibit greatly improved life characteristics.

### BRIEF DESCRIPTION OF THE DRAWINGS

FIG. 1 is a diagram schematically showing the technical principle in which, when an additive (Pyr6(6)⁺-containing additive) of one embodiment of the present disclosure is used, dendritic lithium growth is suppressed and uniform lithium growth is achieved, in comparison with when no additive is used and when the additive (Pyr1(12)⁺) of Comparative Example is used.

FIGS. 2a to 2c are electron micrographs showing a state in which lithium is grown by applying an electric charge on a lithium metal thin film with respect to Comparative Example 1 (without additives), Comparative Example 2 (with Pyr1(12)FSI additive) and Example 1 (with Pyr6(6)FSI additive), respectively, and graphs which calculates and shows the number of lithium tip (protuberance) on each thin film, average protuberance size, and standard deviation.

### DETAILED DESCRIPTION

Throughout the description, when a portion is referred to as “including” or “comprising” a certain component, it means that the portion can further include other components, without excluding the other components, unless otherwise stated. The term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party. Through the whole document, the term “step of” does not mean “step for”.

Through the description, the term “combination of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Embodiments of the present disclosure will now be described in detail based on the above definitions and the accompanying drawings. However, these embodiments are exemplary, the present disclosure is not limited thereto and the present disclosure is defined only by the scope of claims described below.

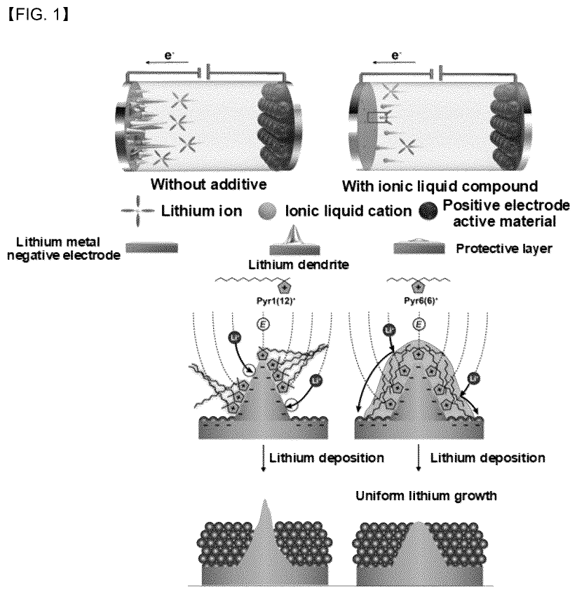

FIG. 1 is a diagram schematically showing the technical principle in which, when an additive (Pyr6(6)⁺) according to one embodiment of the present disclosure is used, dendritic lithium growth is suppressed and uniform lithium growth is performed, in comparison with when no additive is used and when other additives are used.

According to one embodiment of the invention, there is provided an additive for a secondary battery comprising an ionic liquid compound that includes a cation and an anion and is in a liquid state at an atmospheric pressure and at a temperature of 100° C. or less, wherein the cation has a standard reduction potential lower than that of lithium cation (Li⁺) based on a standard hydrogen electrode (SHE), and wherein the cation has a structure in which an even number of aliphatic hydrocarbon groups having 3 or more carbon atoms identical to each other are bonded to a central element of the cation, such that the cation has a symmetrical structure based on the central element.

The additive of one embodiment is an ionic liquid compound that exhibits a liquid state containing cations and anions at the driving or charging/discharging temperature of the secondary battery, for example, atmospheric pressure (e.g., 1 atm) and a temperature of 100° C. or less, or 0 to 100° C., or 20 to 100° C., and can be effectively included as an additive in an electrolyte of a lithium metal battery, such as an electrolyte solution comprising a lithium salt and a non-aqueous organic solvent.

In addition, the cation of the additive of one embodiment may exhibit a standard reduction potential (about −3.04V) lower than that of a lithium cation (Li⁺) based on a standard hydrogen electrode (SHE). Therefore, as also shown in FIG. 1, when the electric field concentrates around the lithium tip or protuberance during charging and discharging, the cations are preferentially reduced over lithium ions by such an electric field and can bind or adsorb to the surface of the lithium metal anode of the lithium tip forming portion. Long-chain aliphatic hydrocarbon groups bonded to these cations can be assembled to form a selective protective layer surrounding the lithium tip. Further, due to the low standard reduction potential, the cations are not decomposed during charging/discharging and operation of a secondary battery such as a lithium metal battery, and can form the protective layer.

Therefore, the additive typically forms a selective protective layer on the lithium tip forming portion where the flow of lithium ions concentrates during charging/discharging of the lithium metal battery, and lithiophobic long-chain aliphatic hydrocarbon groups included in the protective layer repulse lithium ions around the lithium tip, whereby it is possible to suppress rapid growth of dendritic lithium or lithium dendrites from the lithium tip, and to achieve uniform lithium growth as a whole at the anode of the lithium metal thin film.

In addition, since the cations of the additive have a structure in which the long-chain aliphatic hydrocarbon groups identical to each other are bonded in a symmetrical structure, they can exhibit moderated amphiphilicity, and can exhibit low interaction property with the non-aqueous organic solvent and the like contained in the electrolyte solution. Therefore, unlike the case of using an additive having a cation with asymmetrical structure (see the left figure at the bottom of FIG. 1), the phenomenon of self-aggregation of the cations of the additive is reduced (see the right figure at the bottom of FIG. 1), and as a result, it is possible to form a uniform protective layer that entirely covers the lithium tip forming portion. Unlike the same, when the additive containing cations with asymmetric structure is used, due to the self-aggregation phenomenon between cations, the protective layer is not properly formed in some areas around the lithium tip, and dendritic lithium growth or the like may still occur in that region.

Therefore, when the additive of one embodiment is used in an electrolyte to provide a secondary battery such as a lithium metal battery, the growth of dendritic lithium or lithium dendrites on the lithium metal anode can be minimized, and uniform lithium may grow on the lithium metal anode during charge/discharge process.

Therefore, such a lithium metal battery can minimize safety problems such as cell short circuit or ignition caused by the growth of dendritic lithium, maintain high capacity characteristic unique to a lithium metal battery for a long time, and exhibit greatly improved life characteristics.

Meanwhile, in the additive of one embodiment, the cation may have a standard reduction potential of −3.7V to −3.1V, or −3.65V to −3.15V, or −3.6V to −3.3V based on a standard hydrogen electrode. This standard reduction potential may be calculated based on the reduction potential of 0V of the standard hydrogen electrode. As the additive of the ionic liquid compound containing the cation having such a standard reduction potential is used, the additive cations may be preferentially bonded over lithium ions on the lithium tip forming portion during charging and discharging of the lithium metal battery, thus forming a selective protective layer, so that dendritic lithium growth or the like can be more effectively suppressed. Further, due to the above standard reduction potential, the decomposition of the cation during the operation of the battery can be further suppressed.

Further, in the additive of one embodiment, the cation can exhibit the features that a self-diffusivity calculated according to the Stejskal-Tanner equation of the following Equation 1 using the analysis result of PFG-NMR (Pulsed Field Gradient-NMR) is 15×10⁻¹¹ m²·s⁻¹ to 30×10^{31 11} m²·s⁻¹, or 18×10⁻¹¹ m²·s⁻¹ to 28×10⁻¹¹ m²s⁻¹, or 20×10⁻¹¹ m²s·⁻¹ to 25×10⁻¹¹ m²·s⁻¹, and that a hydrodynamic diameter at an absolute temperature of 298K calculated according to the Stockes-Einstein equation of the following Equation 2 using the PFG-NMR analysis results is 1.5 to 3.0 nm, or 1.8 to 2.8 nm, or 2.0 to 2.5 nm.

$$E = exp ( - {γ}^{2} {g}^{2} {δ}^{2} D ( Δ - \frac{δ}{3} ) ) \qquad [ Equation 1 ]$$

wherein, in Equations 1 and 2, E represents the signal attenuation ratio, [symbol] represents the gyromagnetic ratio, g represents the gradient strength, δ (ms) represents the duration pulse, Δ (ms) represents the gradient pulse interval, D represents the self-diffusivity, d represents the hydrodynamic diameter, kB represents the Boltzmann constant, T represents the absolute temperature (e.g., the measured temperature of 298 K), and η represents the viscosity of the solvent.

Such self-diffusivity and hydrodynamic diameter are features that can be calculated according to Equations 1 and 2 from each parameter derived as a result of PFG-NMR analysis of the cation of the ionic liquid compound. These features can reflect the interaction of the cation with non-aqueous organic solvents, the diffusivity, or the self-aggregation property, and the like.

Specifically, as the additive cations of one embodiment have a symmetrical structure in which the long-chain aliphatic hydrocarbon groups identical to each other, for example, the long-chain straight-chain alkyl groups identical to each other, are bonded to each other, they can have greater self-diffusivity and smaller hydrodynamic diameter compared to additive cations of asymmetric structure. This may indicate that the additive cation of one embodiment has relatively low amphiphilicity, for example, low interaction with a non-aqueous organic solvent contained in the electrolyte.

Therefore, as shown in FIG. 1, since the additive of one embodiment having such cations with symmetrical structure has a low tendency to self-aggregate around the lithium tip or protuberance, it can be uniformly adsorbed or bound on the lithium tip to form a protective layer that selectively and uniformly surrounds it. Therefore, by using such an additive, the growth of dendritic lithium or lithium dendrites from the lithium tip can be more effectively suppressed.

In order to effectively exhibit the above characteristics, the long-chain aliphatic hydrocarbon group bonded to the cation may be an alkyl group having 3 or more carbon atoms, or 3 to 20 carbon atoms, or 4 to 15 carbon atoms, or 5 to 10 carbon atoms, and more suitably, it may be a linear alkyl group having such a number of carbon atoms. An even number of these hydrocarbon groups are bonded to the central element of the cation, so that the cation can have a symmetrical structure. Thereby, the growth of dendritic lithium or the like from the lithium tip can be more effectively suppressed.

Meanwhile, according to a specific example, the ionic liquid compound of the additive may be represented by the following Chemical Formula 1, and more specifically, it may be represented by the following Chemical Formula 2:

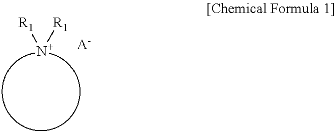

wherein, in Chemical Formula 1,

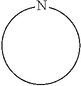

is a nitrogen-containing heterocyclic ring having 3 to 8 carbon atoms, or 4 to 7 carbon atoms, or 5 to 6 carbon atoms, R1s are linear alkyl groups having 3 to 20 carbon atoms, 4 to 15 carbon atoms, or 5 to 10 carbon atoms, which are identical to each other, and A⁻ is an anion.

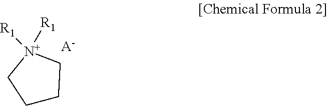

wherein, in Chemical Formula 2, R1s are linear alkyl groups having 3 to 20 carbon atoms, 4 to 15 carbon atoms, or 5 to 10 carbon atoms, which are identical to each other, and A⁻ is an anion.

Specific examples of the additive represented by Chemical Formula 1 or 2 include an ionic liquid compound in which 1,1-dihexylpyrrolidium cation (Pyr6(6)⁺) or a 1,1-dipropylpyrrolidium cation or the like is bonded to an anion A⁻ described below.

As confirmed in the examples below, since such compounds contain linear long chain alkyl groups that are symmetrically bound to pyrrolidium cations, a very uniform and selective protective layer can be formed on the lithium tip forming portion of the lithium metal thin film, it effectively suppresses growth of dendritic lithium or lithium dendrites and enables uniform growth of lithium from a lithium metal anode. Among these compounds, an ionic liquid compound containing a pyrrolidium cation to which a linear alkyl group having 4 or more carbon atoms, or 5 or more carbon atoms, or 5 to 15 carbon atoms is symmetrically bonded can be preferably used in the same manner as the Pyr6(6)³⁰ , in order to more effectively suppress the dendritic lithium growth or the like.

Meanwhile, the additive compounds of Chemical Formula 2 or the like can be prepared by a method of alkylating pyrrolidine with R1-X (where R1 is as defined in Chemical Formula 2, and X is a halogen) or the like in the presence of a base such as potassium carbonate to form a compound of the following Chemical Formula 2A, and reacting the compound of Chemical Formula 2A with LiA (where A is as defined in Chemical Formula 2) or the like.

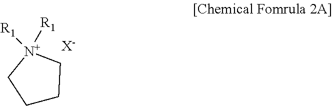

wherein, in Chemical Formula 2A, R1 is as defined in Chemical Formula 2, and X⁻ is a halogen anion.

In the additive of one embodiment described above, the anion bonded to the cation is not particularly limited as long as the additive can become an ionic liquid compound at atmospheric pressure and 100° C. or less, and can be included as an additive in an electrolyte of a lithium metal battery. However, from the viewpoint of forming a more stable solid electrolyte interphase (SEI) film on the lithium metal thin film serving as the anode of the lithium metal battery, the anion is preferably a fluorine-containing anion, more specifically, bis(fluorosulfonyl)imide(FSI) anion, bis((trifluoromethyl)sulfonyl)imide(TFSI) anion, hexafluorophosphate(PF₆) anion or difluoro(oxalato)borate(DFOB) anion.

When such an ionic liquid compound having an anion is used as an electrolyte additive, the reaction between the electrolyte and the lithium metal anode enables formation of a more stable SEI film, e.g., an SEI film containing lithium fluoride (LiF) or lithium nitride (Li₃N), etc. on the anode, while maintaining the excellent ion conductivity of the lithium metal battery, which makes it possible to more effectively suppress the growth of dendritic lithium or lithium dendrites.

The additive of one embodiment described above is preferably used as an additive for an electrolyte of a lithium metal battery, for example, an additive for an electrolyte solution containing a lithium salt and a non-aqueous organic solvent, thereby capable of effectively suppressing the growth of dendritic lithium or lithium dendrites on the anode of a lithium metal battery, making lithium growth uniform in the anode, and greatly improving the safety and life characteristics of a lithium metal battery.

Meanwhile, in the category of a lithium metal battery in which the additive of one embodiment can be used, a so-called lithium-free battery manufactured without forming a separate lithium metal thin film or anode active material layer on the anode current collector may also be included, in addition to a general lithium metal battery manufactured by forming a lithium metal thin film on an anode current collector.

In such a lithium-free battery, lithium metal, which grows on an anode current collector during a charge/discharge process, may act as an anode active material. Even in such a lithium-free battery, the additive can form a protective layer or the like on the lithium metal serving as the anode active material, to thereby effectively suppress non-uniform growth of dendritic lithium or lithium dendrites.

Meanwhile, according to another embodiment of the present disclosure, there is provided a lithium metal battery comprising the above-mentioned additive. Such a lithium metal battery may comprise an anode including a lithium metal thin film formed on the anode current collector; an electrolyte including the above-mentioned additive; and a cathode including a cathode active material layer formed on a cathode current collector.

Such a lithium metal battery may further comprise a protective layer containing the cations of the additive formed on the lithium metal thin film depending on the progress of the charge/discharge process. In particular, the protective layer may be formed so as to selectively cover the lithium tip or protuberance (dendritic lithium growth portion) in the lithium metal thin film where the flow of electric fields and lithium ion concentrates during charging and discharging. Within such a protective layer, the cations of the additive can be uniformly adsorbed or bonded onto the lithium metal thin film of the dendritic lithium growth portion (lithium tip forming portion) without self-aggregation.

Additionally, as the anion of the additive reacts with the lithium metal, an SEI film formed on the lithium metal thin film may be further included, wherein the SEI film may include lithium fluoride(LiF) and/or lithium nitride(Li₃N) as a main component by coupling the lithium ion with fluorine and/or nitrogen derived from the anion of the additive.

Such an SEI film and protective layer can suppress excessive growth of dendritic lithium or the like from the lithium metal thin film, and the ignition, cell short circuit, or the like resulting therefrom, and lithium metal batteries of other embodiments can exhibit improved safety and life characteristics.

Meanwhile, the lithium metal battery of another embodiment may conform to the structure of a general lithium metal battery except for the use of the electrolyte additive described above. Additional configurations of such a lithium metal battery will be described below.

The lithium metal battery according to another embodiment described above includes as an anode a lithium metal thin film formed on an anode current collector. At this time, the anode current collector may be any metal current collector, and typically may be a metal current collector of copper, aluminum or the like.

Such a metal current collector may generally have a thickness of 3 to 500 μm. Also, the lithium metal thin film formed on the metal current collector may be formed to have a thickness of 1 to 100 μm, 5 to 80 μm, or 10 to 60 μm depending on a general construction of a lithium metal battery. In addition, the lithium metal thin film may be formed on the metal current collector through a method widely known in the art, such as deposition, electrolytic plating, and rolling.

Meanwhile, the electrolyte of the lithium metal battery may be an electrolyte solution (liquid electrolyte) containing a non-aqueous organic solvent and a lithium salt.

At this time, the non-aqueous organic solvent serves as a medium through which ions involved in the electrochemical reaction of the battery can move while dissolving the lithium salt and additives.

The type of the non-aqueous organic solvent is not particularly limited, and an ether-based, a carbonate-based, an ester-based, a ketone-based, an alcohol-based, or an aprotic solvent can be used. Examples of the carbonate-based solvent include dimethyl carbonate(DMC), diethyl carbonate(DEC), dipropyl carbonate(DPC), methylpropyl carbonate(MPC), ethylpropyl carbonate(EPC), ethylmethyl carbonate(EMC), methylethyl carbonate(MEC), ethylene carbonate(EC), propylene carbonate(PC), butylene carbonate(BC), and the like. Examples of the ester-based solvent include methyl acetate, ethyl acetate, n-propyl acetate, 1,1-dimethylacetate, methylpropinonate, ethylpropinonate, γ-butyrolactone, decanolide, valerolactone, mevalonolactone, caprolactone, and the like. Examples of the ether-based solvent include dimethyl ether, 1,2-dimethoxyethane, dibutyl ether, tetraglyme, diglyme, 2-methyltetrahydrofuran, tetrahydrofuran, and the like. Examples of the ketone-based solvent include cyclohexanone, and the like. Examples of the alcohol-based solvent include ethanol, isopropylalcohol, and the like. Examples of the aprotic solvent include nitriles such as R—CN (wherein R is a C2˜C20 linear, branched, or cyclic hydrocarbon group, and may include double bonds, aromatic rings, or bonds), amides such as dimethylformamide, dioxolanes such as 1,3-dioxolane, sulfolanes, and the like. Among these, from the viewpoint of improving life characteristics of a lithium metal battery, an ether-based solvent or a carbonate-based solvent can be suitably used.

Further, the non-aqueous organic solvent may be used alone or in combination of one or more, and when the organic solvent is used as a mixture of one or more, its mixing ratio can be appropriately adjusted in accordance with the desired battery performance, which can be widely understood by those skilled in the art.

Moreover, the carbonate-based solvent may be preferably a mixture of a cyclic carbonate and a linear carbonate. In this case, when the cyclic carbonate and the linear carbonate are mixed together in a volume ratio of about 1:1 to about 1:9, the electrolyte can exhibit excellent performance.

The non-aqueous organic solvent may further include the aromatic hydrocarbon-based organic solvent in the carbonate-based solvent. At this time, the carbonate-based solvent and the aromatic hydrocarbon-based organic solvent may be mixed together in a volume ratio of about 1:1 to about 30:1.

Examples of the aromatic hydrocarbon based organic solvent include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and a combination thereof.

The non-aqueous electrolyte further includes vinylene carbonate or an ethylene carbonate-based compound in order to improve battery life.

Representative examples of the ethylene carbonate-based compound include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. When the vinylene carbonate or the ethylene carbonate-based compound is additionally used, the usage amount thereof can be appropriately adjusted to improve the life.

In the electrolyte of the lithium metal battery, the lithium salt is dissolved in the organic solvent and act as a source of lithium ions to enable basic operation of the lithium metal battery of the other embodiment, and improve lithium ion transfer between the cathode and the anode.

The lithium salt may include a lithium salt widely applied to an electrolyte. For example, lithium bis(fluorosulfonyl)imide(LiFSI) or lithium bis((trifluoromethyl)sulfonyl)imide(LiTFSI) can be used. In addition, LiPF₆, LiBF₄, LiSbF₆, LiAsF₆, LiC₄F₉SO₃, LiClO₄, LiAlO₂, LiAlCl₄, LiN(CₓF_{2×+1}SO₂)(C_{y}F_{2y+1}SO₂) (wherein, x and y are natural numbers), LiCl, LiI, LiB(C₂O₄)₂ (lithium bis(oxalato) borate; LiBOB), or a combination thereof can be used.

In the electrolyte, the concentration of the lithium salt can be controlled within the range of 0.1 to 5.0M. The electrolyte may have suitable conductivity and viscosity within this range, and lithium ions may effectively move within the lithium metal battery. However, this is only an example, and the invention is not limited thereby.

The electrolyte may be in the form impregnated into a porous separator located between the anode and the cathode. Here, the porous separator may include anything commonly used in a lithium battery as long as it separates the anode and the cathode from each other, and provides a migration passage for lithium ions. In other words, a material having low resistance against the ion migration of the electrolyte and excellent ability to impregnate the electrolyte can be used.

For example, it may be selected from a glass fiber, polyester, Teflon, polyethylene, polypropylene, polytetrafluoroethylene(PTFE), or a combination thereof. It may have a form of a non-woven fabric or a woven fabric. For example, polyolefin-based polymer separator such as polyethylene, polypropylene or the like is mainly used. In order to ensure the heat resistance or mechanical strength, a coated separator containing a ceramic component or a polymer material may be used, and selectively, it may be used as a mono-layered or multi-layered structure

In addition, the lithium metal battery further includes a cathode including a cathode current collector and a cathode active material layer formed on the cathode current collector.

At this time, the cathode active material layer can be prepared by mixing the cathode active material, the binder, and optionally, a conductive material or a filler, etc. in a solvent to prepare a cathode mixture in a slurry state, and applying the cathode mixture to the cathode current collector. Since such a manufacturing method of the cathode is widely known in the art, a detailed description thereof will be omitted herein.

The cathode active material is not particularly limited as long as it is a material capable of reversibly intercalating and de-intercalating lithium ions. For example, it may include one or more complex oxides of a metal selected from the group consisting of cobalt, manganese, nickel, iron, aluminum, and a combination thereof; and lithium.

More specifically, for example, a compound represented by any one of the following formulas can be used as the cathode active material. LiₐA_{1-b}R_{b}D₂ (where 0.90≤a≤1.8 and 0≤b≤0.5); LiₐE_{1-b}R_{b}O_{2-c}D_{c} (where 0.90≤a≤1.8, 0≤≤0.5, and 0≤c≤0.05); LiE_{2-b}R_{b}O_{4-c}D_{c} (where 0≤b≤0.5, 0≤c≤0.05); LiₐNi_{1-b-c}Co_{b}R_{c}D_{α} (where 0.90≤a≤1.8, 0≤b≤0.5, 0c≤0.05 and 0≤α≤2); LiₐNi_{1-b-c}Co_{b}R_{c}O_{2-α}Z_{α} (where 0.90≤a≤1.8, 0≤b≤0.5, 0≤c≤0.05 and 0≤α≤2); LiₐNi_{1-b-c}Co_{b}R_{c}O_{2-α}Z_{α} (where 0.90≤a≤1.8, 0≤b≤0.5, 0≤c≤0.05 and 0≤α≤2); LiₐNi_{1-b-c}Mn_{b}R_{c}D_{α} (where 0.90≤a≤1.8, 0≤b≤0.5, 0≤c≤0.05 and 0≤α≤2); LiₐNi_{1-b-c}Mn_{b}R_{c}O_{2-α}Z₂ (where 0.90≤a≤1.8, 0≤b≤0.5, 0≤c≤0.05 and 0≤α≤2); LiₐNi_{1-b-c}Mn_{b}R_{c}O_{2-α}Z₂ (where 0.90≤a≤1.8, 0≤b≤0.5, 0≤c≤0.05 and 0≤α≤2); LiₐNi_{b}E_{c}G_{d}O₂ (where 0.90≤a≤1.8, 0≤b≤0.9, 0≤c≤0.5 and 0.001≤d≤0.1); LiₐNi_{b}Co_{c}Mn_{d}GₑO₂ (where 0.90≤a≤1.8, 0≤b≤0.9, 0≤c≤0.5, 0≤d≤0.5 and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂G_{b}O₄ (where 0.90≤a≤1.8 and 0.001≤b≤0.1); QO₂; QS₂; LiQS₂; V₂O₅; LiV₂O₅; LiTO₂; LiNiVO₄; Li_{(3-f)}J₂(PO₄)₃(0≤f≤2); Li_{(3-f)}Fe₂(PO₄)₃(0≤f≤2); and LiFePO4.

In the above formulas, A is Ni, Co, Mn or a combination thereof; R is Al, Ni, Co, Mn, Cr, Fe, Mg, Sr, V, a rare earth element or a combination thereof; D is O, F, S, P or a combination thereof; E is Co, Mn or a combination thereof; Z is F, S, P or a combination thereof; G is Al, Cr, Mn, Fe, Mg, La, Ce, Sr, V or combinations thereof; Q is Ti, Mo, Mn or a combination thereof; T is Cr, V, Fe, Sc, Y or a combination thereof; and J is V, Cr, Mn, Co, Ni, Cu or combinations thereof.

Among these various active materials, a cathode active material that exhibits high capacity characteristics and requires a high level of safety, for example, a cathode active material such as LiₐNi_{b}·Co_{c}Mn_{d}GeO₂ (wherein, 0.90≤a≤1.8, 0.4 b′≤0.95, 0≤c≤0.5, 0≤d≤0.5 and 0≤e≤0.1, G is Al) having a high Ni content ratio or LiFePO4 can be preferably applied to lithium metal batteries of other embodiments.

As the above-mentioned cathode active material, those having a coating layer on the surface of each compound can be used, and a mixture of the above-mentioned compound and a compound having a coating layer can be used. The coating layer may include an oxide of the coating element, a hydroxide of the coating element, an oxyhydroxide of the coating element, an oxycarbonate of the coating element, and a hydroxycarbonate of the coating element. The compounds constituting these coating layers may be amorphous or crystalline compounds. As the coating element included in the coating layer, Mg, Al, Co, K, Na, Ca, Si, Ti, V, Sn, Ge, Ga, B, As, Zr, or a mixture thereof can be used.

The coating layer can be formed using a suitable method (e.g., spray coating, dipping, etc.) that does not adversely affect the physical properties of the cathode active material when a compound of the coating element is used. Since this is the content that can be understood well by those engaged in the relevant field, a detailed explanation thereof is omitted.

Meanwhile, the cathode current collector is typically fabricated to a thickness of 3 to 500 μm. The cathode current collector is not particularly limited as long as it has high conductivity without causing a chemical change in the corresponding battery, and for example, may be formed of stainless steel, aluminum, nickel, titanium, calcinated carbon, or aluminum, or a material formed by surface-treating a surface of stainless steel with carbon, nickel, titanium, silver, or the like. The current collector may have fine protuberances and depressions formed on a surface thereof to enhance adherence of a positive electrode active material, and can be formed in various forms such as a film, a sheet, a foil, a net, a porous body, a foaming body, and a non-woven fabric structure.

The conductive material is not particularly limited as long as it has high conductivity without causing a chemical change in the corresponding battery, and for example, graphite such as natural graphite and artificial graphite; carbon blacks such as carbon black, acetylene black, ketjen black, channel black, furnace black, lamp black, and thermal black; conductive fibers such as carbon fiber and metal fiber; metal powders such as carbon fluoride powder, aluminum powder, and nickel powder; conductive whiskey such as zinc oxide and potassium titanate; conductive metal oxides such as titanium oxide; conductive materials such as polyphenylene derivatives can be used.

The lithium metal battery of one embodiment not only can be used as a unit cell used as a power source for a small-sized device, but also can be used as a unit cell in a medium- or large-sized battery module including a plurality of battery cells. Furthermore, a battery pack including the battery module may be constructed.

Preferred examples of the present disclosure, comparative examples for comparing them, and experimental examples for evaluating them are described below. However, these examples are for illustrative purposes only and are not intended to limit the scope of the present disclosure.

### Example 1: Synthesis of Electrolyte Additive (1,1-dihexylpyrrolidium bis(fluorosulfonyl)imide, Pyr6(6)⁺FSI⁻)

50 mL of acetonitrile, pyrrolidine (3.56 g, 50 mmol) and potassium carbonate (7.60 g, 55 mmol) base were added to a round bottom flask. 1-Bromohexane (24.76 g, 150 mmol) was slowly added to this mixture, and reacted with stirring at 65° C. for 8 hours. Then, the solution was filtered and the solvent was removed from the filtrate under reduced pressure. The residue was rinsed with hexane to obtain 1,1-dihexylpyrrolidium bromide [Pyr6(6)Br] as a yellow solid.

This Pyr6(6)Br was dried under vacuum at 80° C. for 10 hours, and then equal moles of Pyr6(6)Br and LiFSI were dissolved in 20 mL of acetonitrile and stirred at room temperature for 5 hours. The solution was then evaporated under reduced pressure, and 10 mL of dichloromethane was added to the concentrated product. The mixture was then filtered and extracted with water to remove excess salts from the filtrate. The lower organic phase was collected and subjected to a rotary evaporation to remove the solvent. This sample was placed under vacuum at 80° C. for 10 hours to finally produce the additive of Pyr6(6)+FSI⁻ as an orange liquid.

### Comparative Example 1

In the following description, the case where no electrolyte additive was used was referred to as Comparative Example 1.

### Comparative Example 2: Synthesis of Electrolyte Additive (1-dodecyl-1-methylpyrrolidium bis(fluorosulfonyl)imide, Pyr1(12)⁺FSI⁻)

50 mL of acetonitrile and 1-methylpyrrolidine (4.26 g, 50 mmol) were added to a round bottom flask. 1-Bromododecane (14.95 g, 60 mmol) was slowly added to this mixture, and reacted with stirring at 65° C. for 8 hours. Then, the solution was filtered and the solvent was removed from the filtrate under reduced pressure. The residue was rinsed with hexane to obtain 1-dodecyl-1-methylpyrrolidium bromide [Pyr1(12)Br] as a yellow solid.

This Pyr1(12)Br was dried under vacuum at 80° C. for 10 hours, and then equal moles of Pyr1(12)Br and LiFSI were dissolved in 20 mL of acetonitrile and stirred at room temperature for 5 hours. The solution was then evaporated under reduced pressure, and 10 mL of dichloromethane was added to the concentrated product. The mixture was then filtered and extracted with water to remove excess salts from the filtrate. The lower organic phase was collected and subjected to a rotary evaporation to remove the solvent. This sample was placed under vacuum at 80° C. for 10 hours to finally produce the additive of Pyr1(12)+FSI⁻ as a transparent liquid.

### Experimental Example 1: Measurement of Self-Diffusivity and Hydrodynamic Diameter of Additives

The additives of Example 1 and Comparative Example 2 were subjected to 1H-, ⁷Li-, and ¹⁹F-NMR analysis using a liquid 400 MHz NMR analyzer (Bruker). By applying the Stejskal-Tanner equation of the following Equation 1 based on these analysis results, the self-diffusivity of the cations of the additives was calculated.

Additionally, by applying the Stockes-Einstein equation of the following Equation 2 based on the NMR analysis results and the self-diffusivity calculation results, the hydrodynamic diameters of the cations of the additives under the absolute temperature of 298K were calculated.

$$d = \frac{{k}_{B} T}{3 π η D} \qquad [ Equation 2 ]$$

in Equations 1 and 2, E represents the signal attenuation ratio, [symbol] represents the gyromagnetic ratio, g represents the gradient strength, δ (ms) represents the duration pulse, Δ (ms) represents the gradient pulse interval, D represents the self-diffusivity, d represents the hydrodynamic diameter, kB represents the Boltzmann constant, T represents the absolute temperature (e.g., the measured temperature of 298 K), and η represents the viscosity of the solvent.

For reference, in the above NMR analysis results, δ(ms)=3.6, Δ(ms)=80-150 for ¹H-NMR, δ(ms)=4.0, Δ(ms)=300-400 for ⁷Li-NMR, and δ(ms)=2.5-3.2, Δ(ms)=300-500 for ¹⁹F-NMR.

Each physical property value analyzed and calculated by the above method is shown in Table 1 below.

TABLE 1

| | Self-diffusivity | Hydrodynamic diameter |
|---|---|---|
| | (×10⁻¹¹ m² · s⁻¹) | (nm) |
| Example 1 | 20.5 | 2.2 |
| Comparative | 12.9 | 3.6 |
| Example 2 | | |

Referring to Table 1, it was confirmed that although the additives of Example 1 and Comparative Example 2 contain cations having similar molecular sizes, the additive cation of Example 1 exhibits greater self-diffusivity and about 1.6 times lower hydrodynamic diameter than those of Comparative Example 2.

It was confirmed therefrom that the additive cation of Example 1 exhibits moderated amphiphilicity and has a low tendency to self-aggregate, which is advantageous in forming a uniform protective layer surrounding the lithium tip.

### Experimental Example 2: Evaluation of Surface Properties of Lithium Metal Thin Film after Lithium Metal Deposition

The lithium salt of lithium bis(trifluoromethanesulfonyl)imide (LiTFSI) at a concentration of 1 M was dissolved in a mixed solvent of 1,3-dioxolane/1,2-dimethoxyethane (DOL/DME-1:1 (v/v %)) to prepare an electrolyte. This electrolyte to which additive was not added was used as the electrolyte of Comparative Example 1.

In addition, the additive of Example 1 or the additive of Comparative Example 2 was respectively dissolved in the electrolyte at a concentration of 1 M to prepare electrolytes of Example 1 and Comparative Example 2, respectively.

Electrolytic plating was performed using the electrolytes of Example 1 and Comparative Examples 1 and 2, respectively, under the application of a current of 0.1 mAh cm⁻², so that a lithium metal thin film was deposited on each copper current collector (thickness: 18 μm).

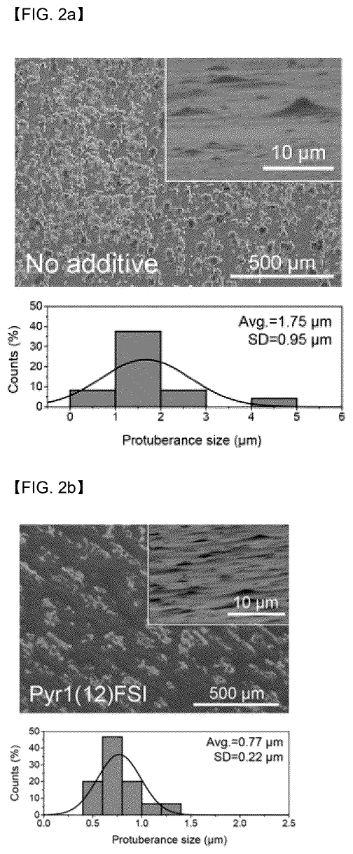

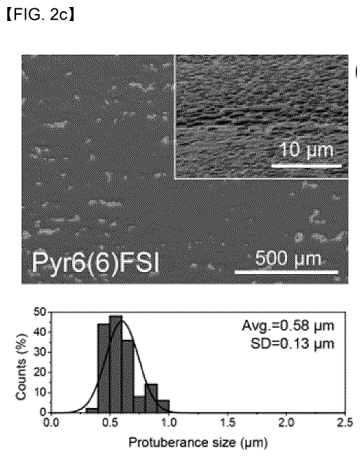

After the progress of deposition, the surface states of the lithium metal thin films for Comparative Example 1 (without additive; FIG. 2a), Comparative Example 2 (with Pyr1(12)FSI additive; FIG. 2b) and Example 1 (with Pyr6(6)FSI additive; FIG. 2c) were confirmed with an electron microscope, and shown in FIGS. 2a to 2c, respectively.

Further, from the surface analysis results of these lithium metal thin films, the number and size of the lithium tip (protuberance) having a size of about 0.25 μm or more were confirmed, respectively. From these confirmation results, the average protuberance size and standard deviation of the lithium tip were calculated, and shown as graphs at the bottom of FIGS. 2a to 2c.

Referring to FIGS. 2a to 2c, it was confirmed that when the additive of Example 1 was used, the number and size of protuberances on the lithium metal thin film were reduced, and a lithium metal thin film having a uniform surface over the entire area of the current collector was formed

This is presumably because the additive of Example 1 forms a uniform protective layer surrounding the protuberances during lithium deposition, thus inducing uniform deposition and growth of lithium, as shown in FIG. 1.

### Experimental Example 3: Evaluation of Life Characteristics of Lithium Metal Battery

A cathode active material of LiNi_{0.6}Co_{0.2}Mn_{0.2}O₂ (NCM622) was used. The cathode active material, carbon black conductive material (super-P), and PVdF binder (Mw=455000; Sigma-Aldrich) were mixed at a weight ratio of 90:5:5 in N-methylpyrrolidone solvent to prepare an anode mixture, which was applied to one surface of an aluminum current collector (thickness: 20 μm), and then dried and rolled in a vacuum oven at 110° C. to fabricate a cathode.

As an anode, a lithium metal thin film (thickness: 40 μm) was formed on one surface of a copper current collector (thickness: 18 μm) and used.

A porous polypropylene separator (Celguard 2325; thickness: 25 μm) was interposed between the cathode and the anode fabricated as above to prepare an electrode assembly. The electrode assembly was placed inside the case, and then an electrolyte solution was injected into the case to fabricate a lithium metal battery.

The electrolyte solution was prepared by dissolving the lithium salt of lithium bis(trifluoromethanesulfonyl) imide (LiTFSI) at a concentration of 1 M in a mixed solvent of 1,3-dioxolane/1,2-dimethoxyethane (DOL/DME—1:1 (v/v %)). Additionally, the additive of Example 1 or the additive of Comparative Example 2 was added to the electrolyte solution at a concentration of 50 mM, respectively, and the lithium metal batteries of Example 1 and Comparative Example 2 were manufactured according to the types of additives in the electrolyte solution.

The respective lithium metal batteries were charged to 4.2V at 0.5C in CCCV mode at 25° C., and was discharged to 3.0V at a constant current of 0.5C. The capacity maintenance rate and coulombic efficiency were measured after 250 charge/discharge experiments were performed. The measurement results of the capacity maintenance rate and coulombic efficiency are summarized in Table 2 below.

TABLE 2

| | | Capacity | |
|---|---|---|---|
| | Number of | maintenance | Coulombic |
| | cycles | rate (%) | efficiency (%) |
| Example 1 | 250 | 78.2 | 99.8 |
| Comparative | 250 | 40.1 | 99.5 |
| Example 2 | | | |

Referring to Table 2, it was confirmed that the lithium metal battery using the symmetrical cation-containing additive of Example 1 exhibit high capacity maintenance rate and coulombic efficiency even after 250 charge/discharge cycles, which exhibit excellent life characteristics.

However, it was confirmed that the lithium metal battery using the asymmetric cation-containing additive of Comparative Example 1 exhibits inferior capacity maintenance and life characteristics compared to Example. This is presumably because the growth of dendritic lithium or lithium dendrites is not sufficiently suppressed when the additive of Comparative Example 1 is used, and the lithium thin film grew non-uniformly during charging/discharging.

1. An additive for a secondary battery, the additive comprising an ionic liquid compound that includes a cation and an anion and is in a liquid state at an atmospheric pressure and at a temperature of 100° C. or less,
wherein the cation has a standard reduction potential lower than that of lithium cation (Li⁺) based on a standard hydrogen electrode (SHE), and
wherein the cation has a structure in which an even number of aliphatic hydrocarbon groups having 3 or more carbon atoms identical to each other are bonded to a central element of the cation such that the cation has a symmetrical structure based on the central element.

2. The additive according to claim 1, wherein the cation has a standard reduction potential of −3.7V to −3.1V based on the standard hydrogen electrode.

3. The additive according to claim 1, wherein the cation has a self-diffusivity of 15*×10⁻¹¹ m²·s⁻¹ to 30*×10⁻¹¹ m²·s⁻¹, which is calculated according to the Stejskal-Tanner equation.

4. The additive according to claim 1, wherein the cation has a hydrodynamic diameter of 1.5 to 3.0 nm, which is calculated according to the Stockes-Einstein equation at an absolute temperature of 298K.

5. The additive according to claim 1, wherein the ionic liquid compound is represented by the following Chemical Formula 1: 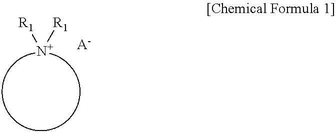
wherein in Chemical Formula 1, 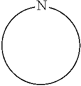
is a nitrogen-containing heterocyclic ring having 3 to 8 carbon atoms,
R1s are linear alkyl groups having 3 to 20 carbon atoms, which are identical to each other, and
A⁻ is an anion.

6. The additive according to claim 5, wherein the ionic liquid compound is represented by the following Chemical Formula 2: 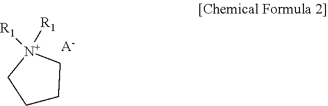
wherein, in Chemical Formula 2,
R₁s are linear alkyl groups having 3 to 20 carbon atoms, which are identical to each other, and
A⁻is an anion.

7. The additive according to claim 1, wherein the anion is selected from the group consisting of fluorine-containing anions.

8. The additive according to claim 1, wherein the anion includes bis(fluorosulfonyl)imide(FSI) anion, bis((trifluoromethyl)sulfonyl)imide(TFSI) anion, hexafluorophosphate (PF₆) anion, or difluoro(oxalato)borate (DFOB) anion.

9. The additive according to claim 1, wherein the additive is included in an electrolyte of a lithium metal battery.

10. A lithium metal battery comprising:
an anode including a lithium metal thin film formed on the anode current collector;
an electrolyte including the additive of claim 1; and
a cathode including a cathode active material layer formed on a cathode current collector.

11. The lithium metal battery according to claim 10, wherein the lithium metal battery further comprises a protective layer formed on the lithium metal thin film and containing the cations of the additive.

12. The lithium metal battery according to claim 11, wherein the cations of the additive selectively cover dendritic lithium protruding from the lithium metal thin film.

13. The lithium metal battery according to claim 10, wherein the lithium metal battery further comprises a solid electrolyte interphase (SEI) film formed on the lithium metal thin film.

14. The lithium metal battery according to claim 13, wherein the solid electrolyte interface film includes lithium fluoride (LiF) or lithium nitride (Li₃N).

15. The lithium metal battery according to claim 10, wherein the cathode active material layer includes one or more complex oxides of a metal selected from cobalt, manganese, nickel, iron, aluminum, and a combination thereof; and lithium.

16. The lithium metal battery according to claim 12, wherein the electrolyte further comprises:
at least one lithium salt selected from the group consisting of lithium bis(fluorosulfonyl)imide(LiFSI), lithium bis((trifluoromethyl)sulfonyl)imide(LiTFSI), LiPF₆, LiBF₄, LiSbF₆, LiAsF₆, LiC₄F₉SO₃, LiClO₄, LiAlO₂, LiAlCl₄, LiN(CₓF_{2×+1}SO₂)(C_{y}F_{2y+1}SO₂) where x and y are each independently a natural number, LiCl, LiI, and LiB(C₂O₄)₂; and
a non-aqueous organic solvent.
